(19) United States
(12) Patent Application Publication
(10) Pub. No.: US 2012/0117040 A1
(43) Pub. Date: May 10, 2012

(54) Method and System for Verifying Data Stored on a Medium

(75) Inventors: David G. Hostetter, Louisville, CO (US); Dennis E. Appleyard, Boulder, CO (US); Dale C. LaFollette, Erie, CO (US)

(73) Assignee: ORACLE INTERNATIONAL CORPORATON, Redwood City, CA (US)

(21) Appl. No.: 12/943,244

(22) Filed: Nov. 10, 2010

(51) Int. Cl. G06F 17/30

(52) U.S. Cl. 707/697; 707/E17.005

(57) ABSTRACT

In a data storage system having a server and a media drive, a method and system for verifying data stored on a medium. The method includes reading, at the media drive in response to a verify command indicative of a user request to perform data verification, a logical record stored on the medium, where the logical record comprising data and a first checksum. The method also includes generating, at the media drive, a second checksum based on the data of the logical record read, and comparing, at the media drive, the second checksum generated at the media drive and the first checksum. The method still further includes communicating, from the media drive to the server, a status indication based on the comparison of the first checksum and the second checksum, where the status indication is representative of a result of the requested data verification.

### TECHNICAL FIELD

The following relates to a method and system for verifying data stored on a medium in a data storage system having a server and a media drive.

### BACKGROUND

Tape media, such as magnetic tape, are frequently used for long-term storage of large quantities of data, such as in data backup or archive operations. As more and more data is stored on tape media, users of such media grow increasingly concerned that the data being stored is “good” (i.e., that the data has been successfully recorded on the media), such that it will be available for recovery and use at a later time.

As a result, after data is stored or written to the tape media, users may perform a verify step to check whether the stored data is good. Such data verification involves reading back the data stored on the tape media and comparing the data read back to a known “good” copy of the data obtained from another media, typically a copy of the data stored on a disk media. Such a data verification process is costly, occupying communication and server resources and time.

As well, more and more users employ the cloud storage world for storage of data on tape media. The use of such cloud networks, which may include the Internet, results in the need for online data verification. However, online data verification in the fashion described requires the allocation of significant bandwidth for communication between a server and media drive. Because online charges are often based on bandwidth allocation, online data verification is also costly.

Thus, there exists a need for a data verification process that reduces the costs associated with such a process. Such a method and system for data verification would perform much of the operations associated with data verification at the media drive, thereby reducing the communication and server resources required, such as online bandwidth allocated.

### SUMMARY

According to one embodiment disclosed herein, in a data storage system having a server and a media drive, a method for verifying data stored on a medium is provided. The method comprises reading, at the media drive in response to a verify command indicative of a user request to perform data verification, a logical record stored on the medium, the logical record comprising data and a first checksum.

The method further comprises generating, at the media drive, a second checksum based on the data of the logical record read, and comparing, at the media drive, the second checksum generated at the media drive and the first checksum. The method still further comprises communicating, from the media drive to the server, a status indication based on the comparison of the first checksum and the second checksum, the status indication representative of a result of the requested data verification.

According to another embodiment, in a data storage system having a server and a media drive, a system for verifying data stored on a medium is provided. The system comprises a controller at the media drive for receiving, as a result of a verify command indicative of a user request to perform data verification, a logical record read from the medium by the media drive, the logical record comprising data and a first checksum.

The controller is further for generating a second checksum based on the data of the logical record, comparing the first checksum and the second checksum, and generating a status indication based on the comparison of the first checksum and the second checksum. The system further comprises a communications interface at the media drive for communicating to the server the status indication, wherein the status indication is representative of a result of the requested data verification.

According to a further embodiment, in a data storage system having a server, a media drive and a medium associated with the media drive, a storage medium having non-transitory computer executable instructions recorded thereon for use in verifying data stored on the medium associated with the media drive is provided. The computer executable instructions comprise instructions for storing, at the media drive in response to a verify command indicative of a user request to perform data verification, a logical record read from the medium associated with the media drive, the logical record comprising data and a first checksum.

The computer executable instructions further comprise instructions for generating, at the media drive, a second checksum based on the data of the logical record read, and comparing, at the media drive, the second checksum generated at the media drive and the first checksum. The computer executable instructions still further comprise instructions for communicating, from the media drive to the server, a status indication based on the comparison of the first checksum and the second checksum, the status indication representative of a result of the requested data verification.

A detailed description of these embodiments and accompanying drawings is set forth below.

### BRIEF DESCRIPTION OF THE DRAWINGS

FIG. 1 is a simplified flowchart of one embodiment disclosed herein for data verification in a data storage system including a server and a media drive;

FIG. 2 is a simplified block diagram of one embodiment of a system disclosed herein for data verification in a data storage system including a server and a media drive; and

FIG. 3 is a simplified flowchart of one embodiment of a method disclosed herein for data verification in a data storage system including a server and a media drive.

### DETAILED DESCRIPTION

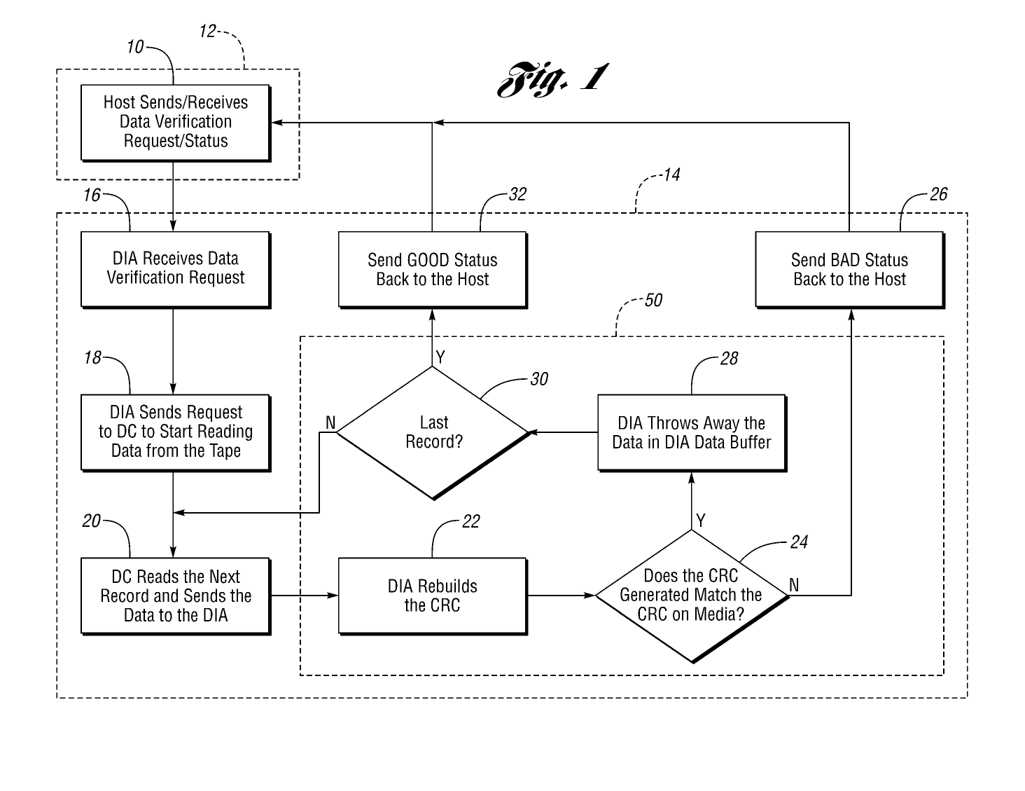

With reference to FIGS. 1-3, a data verification process for use in a data storage system will be described. For ease of illustration and to facilitate understanding, like reference numerals have been used herein for like components and features throughout the drawings.

As previously described, existing data verification processes undertake to read from a tape medium all of the data that had been sent from a server to a media drive and written to the tape. All such data read from the tape is sent from the media drive back to the server, which compares that data to another copy of the data, such as one stored on a disk medium, to determine if the data is good or if any errors occurred in writing the data to the tape medium.

The method and system disclosed herein utilize and build on end-to-end protection features in existing tape drive systems. Such end-to-end protection features provide for storing not only the data of a logical record, but also a checksum for such data, on the tape medium. Storage of the checksum on the medium allows the data verification features internal to the media drive to be used advantageously.

In that regard, a user may make a request to the tape drive to perform data verification. The tape drive, upon receipt of such a request, begins reading the logical records previously stored on the tape medium, including the data and the checksum of those logical records. Hardware at the tape drive may be used to generate or re-build/re-create/re-generate the checksum from the data of the logical record, and compare the re-generated checksum against the checksum stored with the data on the tape media for that logical record. Such actions appear as simply normal read operations for the tape drive hardware. Such actions also appear as simply data verify operations for associated firmware, which as a result discards the data of a logical record stored in cache, a buffer or other temporary memory, and continues reading logical records from the tape.

The end result is that the tape drive may be used to verify the data stored on the tape medium at tape operating speeds, without any data having to be sent from the media drive to the server over the cloud network and communication links (e.g., fibre channels) therebetween. While the user has a verify command pending until the process is complete, the server is free to perform other duties. Moreover, if the data has a verification problem, the user is notified immediately as to which logical record is bad.

According to the method and system disclosed herein, then, in response to a data verification request made by a user, a controller at the media drive generates, re-creates or re-builds a checksum or Cyclic Redundancy Check (“CRC”) from the data of a logical record read from the tape medium. As well, a CRC for the logical record is also read from the tape medium, which CRC was previously calculated by the server and sent to the media drive with the data of the logical record to be written to the tape by the media drive.

The controller then compares the re-created or re-built CRC for the logical record generated by the controller to the CRC for the logical record previously appended by the server and read from the tape medium. The result of such a comparison serves as an indication whether the data of the logical record is good or bad, and the media drive simply sends a status indication to the server representative of the result of the data verification request made by the user.

Thus, according to the data verification method and system disclosed herein, significantly less data is sent from the media drive to the server for data verification or error check purposes. Such a method and system provide for faster, less costly data verification, as less communication bandwidth between the server and the media drive is required.

More specifically, referring now to FIG. 1, a simplified flowchart of one embodiment of a data verification process as disclosed herein is shown, which may be referred to as Data Integrity Validation (“DIV”) or Digital Archive Data Protection (“DADP”). As seen therein, a data verification request may be sent (10) by a user from a host or server (12) to a media drive (14). The data verification request is received (16) by the media drive (14), such as through the use of a Digital Interface Adapter (“DIA”), which may comprise an interface card or equivalent hardware, software and/or firmware. The DIA may then send (18) the data verification request to a Data Conditioner (“DC”), which again may comprise a card or the equivalent, in order to thereby start the process of reading data from the tape medium. As a result, the DC may then read (20) the next logical record comprising data and a CRC or checksum from the tape medium, and send that data and CRC to the DIA.

Upon receiving the data and CRC of the logical record read by the DC from the tape, the DIA may then generate (22) or re-build or re-create a CRC from the data received, and compare (24) the generated CRC to the CRC of the logical record read from the tape. If the CRC or checksum generated by the DIA does not match the CRC or checksum read from the tape, a status indication may be sent (26) back to the server (12) indicating that the data of the logical record is bad (i.e., that the data of the logical record was not previously written to the tape medium successfully). Such a status indication may also include an identification of the particular logical record having such bad data.

Alternatively, if the CRC generated by the DIA matches the CRC read from the tape, then the data from the logical record, which had been stored in a buffer, cache or temporary memory, is discarded (28) by the DIA. Thereafter, it is determined (30) whether the last logical record has been read from the tape medium. If not, then the DC reads the next logical record from the tape medium, and sends (20) the data and CRC of that logical record to the DIA, which once again generates (22) a CRC from the data received, compares (24) the generated CRC to the CRC read from the tape for that logical record, and may send (26) a bad status indication to the server (12) if the generated CRC and the CRC read from the tape fail to match.

Referring still to FIG. 1, when it is determined (30) that the last logical record has been read from the tape, a status indication may be sent (32) back to the server (12) indicating that the data of all the logical records is good (i.e., that the data of all the logical records was written to the tape medium successfully). In that regard, it can be seen from the foregoing description that a single data verification request may result in a status indication verifying the data stored on the entire tape (i.e., verifying the data of all the logical records on the tape medium rather than simply a single logical record).

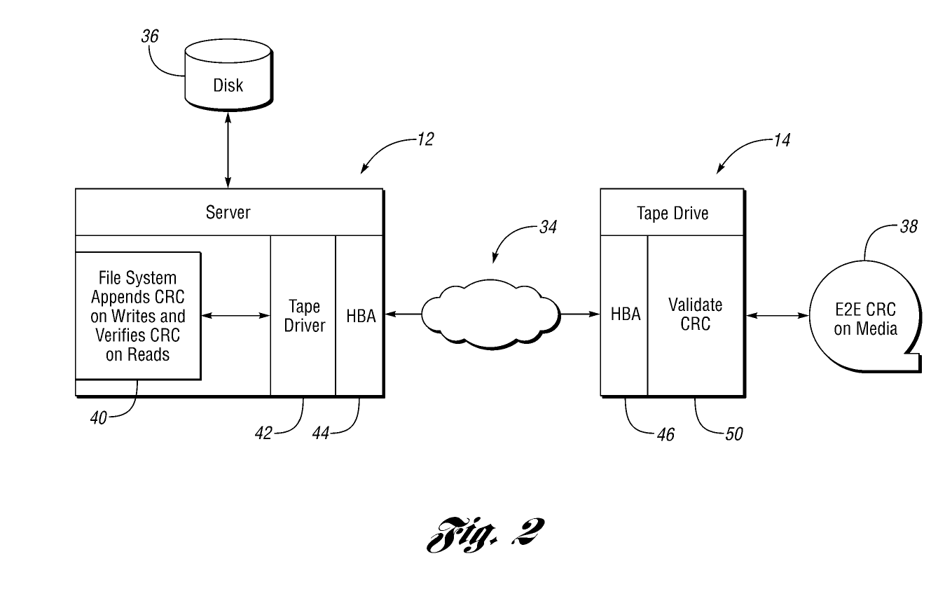

Referring now to FIG. 2, a simplified block diagram of an embodiment of a system for data verification is shown. As seen therein, the system for data verification is for use in a data storage system that includes a server (12) and a media drive (14), such as a tape drive.

The server (12) and media drive (14) may be provided in communication over a cloud network (34), which may comprise the Internet. The server (12) may also be provided in communication with a disk storage medium (36), and the media drive (14) may also be provided in communication with a medium (38) for storing data, such as a tape maintained in a tape cartridge.

The server (12) may include a file system (40) that appends a checksum or CRC as part of a logical record for write operations, and that verifies a checksum or CRC for read operations. The file system (40) communicates with a tape driver (42), which communicates with a Host Bus Adaptor (“HBA”) (44). The HBA (44) may act as a communications interface between the server (12) and the cloud network (34).

Referring still to FIG. 2, the media drive (14) may also comprise a HBA (46), which may act as a communications interface between the media drive (14) and the cloud network (34). The media drive (14) may also include a controller (50), which may comprise appropriate hardware, software and/or firmware as required or desired for performing the various operations of the system and method described herein.

In that regard, as described in detail above, the controller (50) is for receiving, as a result of a verify command indicative of a user request to perform data verification, a logical record read from the medium (38), where the logical record comprises data and a first checksum appended by the file system (40) of the server (12). The controller (50) is also for generating a second checksum based on the data of the logical record, comparing the first checksum and the second checksum, and generating a status indication based on the comparison of the first checksum and the second checksum. The HBA (46) of the media drive (14) is for communicating the status indication to the server (12), such as via the cloud network (34), where the status indication is representative of a result of the requested data verification.

It should be noted that the HBA (46) of the media drive (14) is also for receiving logical records sent from the server (12), again such as via the cloud network (34), and for receiving the verify command indicative of the user request to perform data verification. It should further be noted that the media drive (14) is also for storing the logical records sent from the server (12) on the medium (38). It should still further be noted that the status indication communicated from the media drive (14) to the server (12) may comprise a positive indication when the first checksum of the logical record stored on the medium (38) matches the second checksum generated by the controller (50) from the data of the logical record read from the medium (38). As well, the status indication communicated from the media drive (14) to the server (12) may also comprise a negative indication when the first checksum fails to match the second checksum, and in that case may further comprise an identification of the logical record involved.

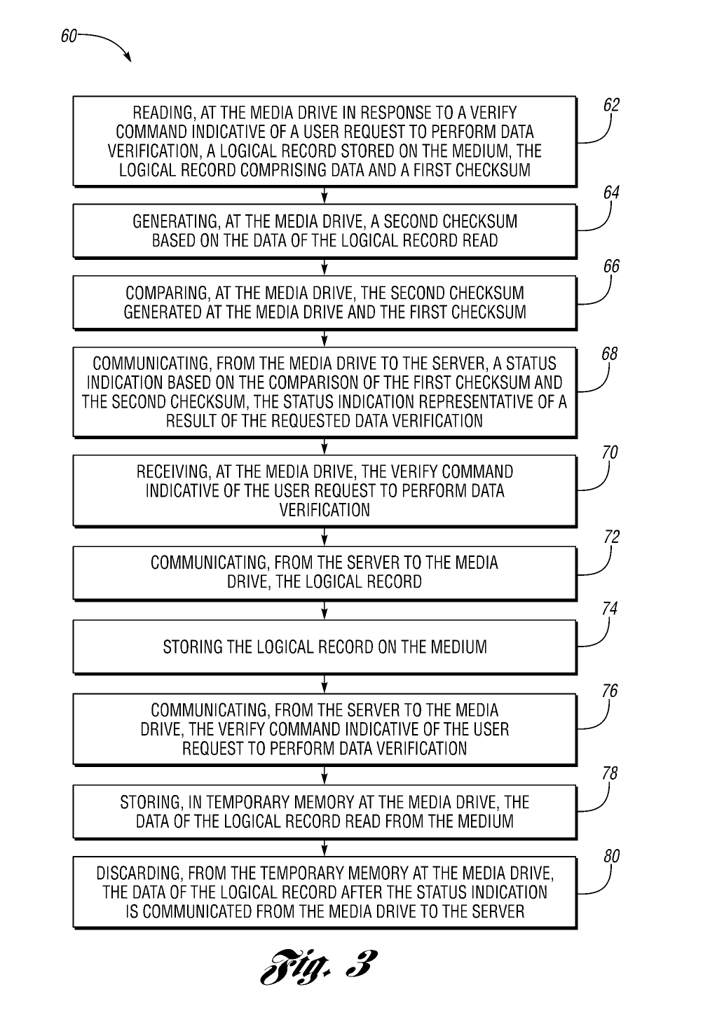

Referring next to FIG. 3, simplified flowchart of an embodiment of a method (60) disclosed herein for data verification is shown. The method (60) is for use in a data storage system having a server and a media drive. As seen in FIG. 3, the method (60) may comprise reading (62), at the media drive in response to a verify command indicative of a user request to perform data verification, a logical record stored on the medium, the logical record comprising data and a first checksum. The method may further comprise generating (64), at the media drive, a second checksum based on the data of the logical record read, and comparing (66), at the media drive, the second checksum generated at the media drive and the first checksum. The method may still further comprise communicating (68), from the media drive to the server, a status indication based on the comparison of the first checksum and the second checksum, the status indication representative of a result of the requested data verification.

The method (60) may also comprise receiving (70), at the media drive, the verify command indicative of the user request to perform data verification. The method (60) may further comprise communicating (72), from the server to the media drive, the logical record, as well as storing (74) the logical record on the medium and communicating (76), from the server to the media drive, the verify command indicative of the user request to perform data verification. The method (60) may still further comprise storing (78), in temporary memory at the media drive, the data of the logical record read from the medium, and discarding (80), from the temporary memory at the media drive, the data of the logical record after the status indication is communicated from the media drive to the server.

Once again, it should be noted that the status indication communicated from the media drive to the server may comprise a positive indication when the first checksum matches the second checksum. As well, the status indication communicated from the media drive to the server may also comprise a negative indication when the first checksum fails to match the second checksum, and in that case may further comprise an identification of the logical record involved. It should also be noted that the operations of the method (60) described herein may be performed in the sequence described, or in any other sequence or combination as appropriate or desired.

According to a further embodiment, in a data storage system having a server, a media drive and a medium associated with the media drive, a storage medium may also be provided having non-transitory computer executable instructions recorded thereon for use in verifying data stored on the medium associated with the media drive is provided. The computer executable instructions may comprise instructions for storing, at the media drive in response to a verify command indicative of a user request to perform data verification, a logical record read from the medium associated with the media drive, the logical record comprising data and a first checksum. The computer executable instructions may further comprise instructions for generating, at the media drive, a second checksum based on the data of the logical record read, and comparing, at the media drive, the second checksum generated at the media drive and the first checksum. The computer executable instructions may still further comprise instructions for communicating, from the media drive to the server, a status indication based on the comparison of the first checksum and the second checksum, the status indication representative of a result of the requested data verification. The computer executable instructions may also comprise instructions for discarding, at the media drive after the status indication is communicated to the server, the stored data of the logical record read from the medium associated with the media drive.

The storage medium having these non-transitory computer executable instructions recorded thereon may comprise the controller (50) described above in connection with FIG. 2, or any other appropriate or desired storage medium, hardware, firmware or any combination thereof. It should also again be noted that the status indication communicated from the media drive to the server may comprise a positive indication when the first checksum matches the second checksum. As well, the status indication communicated from the media drive to the server may also comprise a negative indication when the first checksum fails to match the second checksum, and in that case may further comprise an identification of the logical record involved.

As is readily apparent from the foregoing description, method and system for verifying data stored on a media have been disclosed for use in a data storage system having a server and a media drive. The method and system perform much of the operations associated with data verification outside the server at the media drive, thereby reducing costs associated with data verification by reducing the communication and server resources required, such as bandwidth allocated in an online data verification process.

While certain embodiments of a method and system for verifying data in a data storage system having a server and a media drive been illustrated and described herein, they are exemplary only and it is not intended that these embodiments illustrate and describe all those possible. Rather, the words used herein are words of description rather than limitation, and it is understood that various changes may be made without departing from the spirit and scope of the following claims.

What is claimed is:

1. In a data storage system having a server and a media drive, a method for verifying data stored on a medium, the method comprising:
reading, at the media drive in response to a verify command indicative of a user request to perform data verification, a logical record stored on the medium, the logical record comprising data and a first checksum;
generating, at the media drive, a second checksum based on the data of the logical record read;
comparing, at the media drive, the second checksum generated at the media drive and the first checksum; and
communicating, from the media drive to the server, a status indication based on the comparison of the first checksum and the second checksum, the status indication representative of a result of the requested data verification.

2. The method of claim 1 further comprising receiving, at the media drive, the verify command indicative of the user request to perform data verification.

3. The method of claim 1 further comprising:
communicating, from the server to the media drive, the logical record;
storing the logical record on the medium; and
communicating, from the server to the media drive, the verify command indicative of the user request to perform data verification.

4. The method of claim 1 wherein the status indication comprises a positive indication when the second checksum generated at the media drive matches the first checksum.

5. The method of claim 1 wherein the status indication comprises a negative indication and an identification of the logical record when the second checksum generated at the media drive fails to match the first checksum.

6. The method of claim 1 further comprising:
storing, in temporary memory at the media drive, the data of the logical record read from the medium; and
discarding, from the temporary memory at the media drive, the data of the logical record after the status indication is communicated from the media drive to the server.

7. The method of claim 1 wherein the medium comprises a tape, and the media drive comprises a tape drive.

8. The method of claim 1 wherein the server and the media drive are provided in communication over a cloud network, and the status indication communicated from the media drive to the server minimizes communication bandwidth required for the requested data verification.

9. In a data storage system having a server and a media drive, a system for verifying data stored on a medium, the system comprising:
a controller at the media drive for
receiving, as a result of a verify command indicative of a user request to perform data verification, a logical record read from the medium by the media drive, the logical record comprising data and a first checksum,
generating a second checksum based on the data of the logical record,
comparing the first checksum and the second checksum, and
generating a status indication based on the comparison of the first checksum and the second checksum; and
a communications interface at the media drive for communicating to the server the status indication, wherein the status indication is representative of a result of the requested data verification.

10. The system of claim 9 wherein the communications interface is also for receiving the logical record from the server, the media drive is for storing the logical record on the medium, and the communications interface is further for receiving the verify command indicative of the user request to perform data verification.

11. The system of claim 9 wherein the status indication comprises a positive indication when the first checksum matches the second checksum.

12. The system of claim 9 wherein the status indication comprises a negative indication and an identification of the logical record when the first checksum fails to match the second checksum.

13. The system of claim 9 wherein the medium comprises a tape, and the media drive comprises a tape drive.

14. The system of claim 9 wherein the server and the media drive are provided in communication over a cloud network, and the status indication communicated from the media drive to the server minimizes communication bandwidth required for the requested data verification.

15. In a data storage system having a server, a media drive and a medium associated with the media drive, a storage medium having non-transitory computer executable instructions recorded thereon for use in verifying data stored on the medium associated with the media drive, the computer executable instructions comprising instructions for:
storing, at the media drive in response to a verify command indicative of a user request to perform data verification, a logical record read from the medium associated with the media drive, the logical record comprising data and a first checksum;
generating, at the media drive, a second checksum based on the data of the logical record read;
comparing, at the media drive, the second checksum generated at the media drive and the first checksum; and
communicating, from the media drive to the server, a status indication based on the comparison of the first checksum and the second checksum, the status indication representative of a result of the requested data verification.

16. The storage medium of claim 15 wherein the status indication comprises a positive indication when the first checksum matches the second checksum.

17. The storage medium of claim 15 wherein the status indication comprises a negative indication and an identification of the logical record when the first checksum fails to match the second checksum.

18. The storage medium of claim 15 wherein the computer executable instructions further comprise instructions for discarding, at the media drive after the status indication is communicated to the server, the stored data of the logical record read from the medium associated with the media drive.

19. The storage medium of claim 15 wherein the medium associated with the media drive comprises a tape, and the media drive comprises a tape drive.

20. The storage medium of claim 15 wherein the server and the media drive are provided in communication over a cloud network, and the status indication communicated from the media drive to the server minimizes communication bandwidth required for the requested data verification.
